(19) United States
(12) Patent Application Publication
(10) Pub. No.: US 2005/0120037 A1
(43) Pub. Date: Jun. 2, 2005

(54) Apparatus and method for managing network storage, and computer product

(75) Inventors: Tetsutaro Maruyama, Kawasaki (JP); Yoshitake Shinkai, Kawasaki (JP)

Correspondence Address: STAAS & HALSEY LLP, SUITE 700, 1201 NEW YORK AVENUE, N.W., WASHINGTON, DC, 20005, US

(73) Assignee: Fujitsu Limited, Kawasaki (JP)

(21) Appl. No.: 11/019,178

(22) Filed: Dec. 23, 2004

Related U.S. Application Data
(63) Continuation of application No. PCT/JP02/07222, filed on Jul. 16, 2002.

(51) Int. Cl. G06F 7/00; G06F 17/00; G06F 15/16; G06F 15/167

(52) U.S. Cl. 707/100; 709/213; 709/217

(57) ABSTRACT

A network storage management apparatus is connected to a client and a storage device via a network. The network storage management apparatus includes a protocol converting unit that performs a conversion of NAS and SAN communication protocols and an internal protocol, a pool field that uses a B-Tree to store data that manages an available field of the storage device, a file space that uses the B-Tree to store data that manages an occupied field of the storage device, a field allocating unit that uses the data in the pool field to allocate the available field, and a field releasing unit that uses the data in the pool field and the file space to manage the storage device.

### BACKGROUND OF THE INVENTION

1) Field of the Invention

The present invention relates to a technology in which an integrated management of data is performed by connecting a plurality of storage devices to a network.

2) Description of the Related Art

In recent years, concurrent with a rapid increase in the volume of data due to the use of multimedia data and the like, storage systems which isolate large-scale data from an application server and manage an integrated operation of only the data are rapidly becoming popular.

For example, in a SAN (Storage Area Network), storage devices such as large-capacity hard disks and the like are connected by a dedicated network called a “storage network” which supplies large-scale data fields to users.

Such a storage system is enlarged as the scope and the amount of data that is to be handled expands. Moreover, sometimes a bigger storage system is constructed by merging a plurality of existing storage systems that manage partial data.

However, there is a problem when merging a plurality of storage systems. Quite often each storage system uses a differing communication protocol; so the work of merging storage systems becomes extremely difficult because various modifications are required for the integration. It is for this reason that a technology that assimilates the differences of the communication protocols and facilitates the integration of a plurality of storage systems becomes important.

Japan Patent Application Laid-Open Publication No. 2000-339098 discloses a conventional technology that makes the integration of a plurality of storage systems easy. According to the conventional technology, the differences between the SAN communication protocols of various storage area networks are assimilated to make the construction of a type of integrated multi-protocol storage system feasible.

However, the conventional technology is intended to work only on storage area networks (SAN), and not on network attached storage (NAS), which are also becoming popular along with the SAN as a means of network storage. Accordingly, there is the problem that the conventional technology cannot be applied to a storage system that incorporates both SAN and NAS.

In other words, in a SAN, a server and the storage devices are connected by a dedicated storage network, and SCSI (Small Computer System Interface) protocol is used for direct access to the storage devices. On the other hand, in a NAS, a server is connected to a NAS server via a LAN; and NFS (Network File System) protocol is used as the communication protocol for the NAS server to access the storage devices. Since the SAN and the NAS are fundamentally using completely different communication protocols, it has been impossible to use both the SAN and the NAS protocols to construct a multi-protocol storage system.

### SUMMARY OF THE INVENTION

It is an object of the present invention to solve at least the problems in the conventional technology.

A network storage management apparatus according to an aspect of the present invention connects a client and a storage device via a network. The network storage management apparatus includes an available-field-information storing unit that manages the storage device as a collection of partial fields, wherein an identifier is allocated to each partial field, collects identifiers of available partial fields, and stores the identifiers collected as information relating to an available field; a field allocating unit that secures an available field based on the information relating to the available field, and from the information relating to the available field deletes the identifiers of the partial fields corresponding to the available field so as to convert the available field into an occupied field; and a field releasing unit that releases the occupied field that has become unnecessary so as to convert the occupied field into an available field by adding identifiers in the information relating to the available field corresponding to the partial fields of the occupied field.

A method of managing storage devices according to another aspect of the present invention is executed in a storage management apparatus that connects a client and a storage device via a network. The method includes managing the storage device as a collection of partial fields, wherein an identifier is allocated to each partial field, collects identifiers of available partial fields, and stores the identifiers collected as information relating to the available field; securing an available field based on the information relating to the available field, and from the information relating to the available field deleting the identifiers of the available partial fields corresponding to the available fields so as to convert the available field into an occupied field; and releasing the occupied field that has become unnecessary so as to convert the occupied field into an available field by adding identifiers in the information relating to the available field corresponding to the partial fields of the occupied field.

A computer-readable recording medium according to still another aspect of the present invention stores a computer program which when executed on a computer realizes the above method according to the present invention.

The other objects, features, and advantages of the present invention are specifically set forth in or will become apparent from the following detailed description of the invention when read in conjunction with the accompanying drawings.

### BRIEF DESCRIPTION OF THE DRAWINGS

FIG. 1 is a diagram of a system configuration of a storage system according to an embodiment of the present invention;

FIG. 2 is an exemplary diagram of data structure of a pool field;

FIG. 3A is an exemplary diagram of data structure of an entire, file space;

FIG. 3B is an exemplary diagram of data structure of a file space of a single node;

FIG. 4 is a flowchart of a process procedure performed by the field allocating unit shown in FIG. 1;

FIG. 5 is a flowchart of a process procedure performed by the field releasing unit shown in FIG. 1;

FIG. 6 is a diagram of a computer system that executes a computer program according to the present embodiment; and

FIG. 7 is a block diagram of a functional configuration of a main unit shown in FIG. 6.

### DETAILED DESCRIPTION

Exemplary embodiments of the present invention will be described below with reference to accompanying drawings.

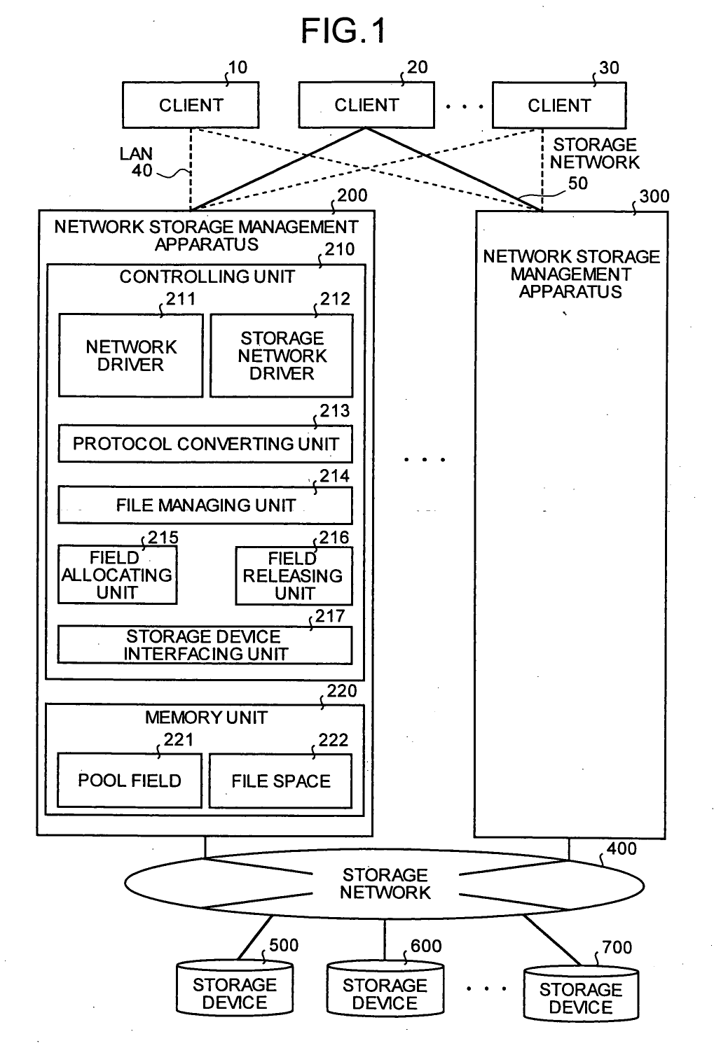

FIG. 1 is a diagram of a system configuration of a storage system according to an embodiment of the present invention. In this storage system, network storage management apparatuses 200 and 300 are connected to storage devices 500 to 700 via a storage network 400. Moreover, the network storage management apparatuses 200 and 300 are connected to clients 10 and 30 via a LAN 40 and the network storage management apparatuses 200 and 300 are connected to a client 20 via a storage network 50. To simplify the explanation, three clients, two network storage management apparatuses, and three storage devices are shown, but any number of apparatuses is possible.

The network storage management apparatuses 200 and 300 manage data to be used by the clients 10 to 30 in the storage devices 500 to 700. The storage devices 500 to 700 are large-capacity hard disks that store data.

The network storage management apparatuses 200 and 300 have the same configuration, so the network storage management apparatus 200 is used as the example in the following explanation. The network storage management apparatus 200 includes a controlling unit 210 and a memory unit 220. The controlling unit 210 is a processing unit that receives commands from the clients 10 to 30 and manages the data of the storage devices 500 to 700. The controlling unit 210 includes a network driver 211, a storage network driver 212, a protocol converting unit 213, a file managing unit 214, a field allocating unit 215, a field releasing unit 216, and a storage device interfacing unit 217. The memory unit 220 stores data for the management of the storage devices 500 to 700. The memory unit 220 includes a pool field 221 and a file space 222.

The network driver 211 communicates, using NFS protocol, with the clients 10 and 30 via the LAN 40. The storage network driver 212 communicates, using SCSI protocol, with the client 20 via the storage network 50.

The protocol converting unit 213 converts the NFS protocol used by the network driver 211, the SCSI protocol used by the storage network driver 212, and the internal protocol used within the network storage management apparatus 200 into each other. This allows the co-existence of both NAS and SAN architectures within one storage system.

In the NAS architecture, the network storage management apparatus 200 accesses a file as a single unit. The network storage management apparatus 200 also manages the file as a single unit. Accordingly, the protocol converting unit 213 can easily perform conversion of protocol by making the network storage management apparatus 200 respond to a NAS file as-is.

On the other hand, in the SAN architecture, the network storage management apparatus 200 does not access a file, but a device ID, a data storage starting address, and a data size that identify a device. Accordingly, the protocol converting unit 213 converts the SAN protocol to the internal protocol of the network storage management apparatus 200 by making the data storage start address within the SAN device correspond to the leading address of the converted file.

The file managing unit 214 manages the files stored as data in the storage devices 500 to 700. The file managing unit 214 performs processing such as creating, reading, renewing, deleting, and the like of files in accordance with instructions from the clients 10 to 30.

The field allocating unit 215 secures a required amount of available fields from the storage devices 500 to 700 in accordance with a field allocation request from the file managing unit 214. The field allocating unit 215 searches for available fields based on the data stored in the pool field 221. Moreover, this field allocating unit 215 renews the file space 222 in accordance with the secured field.

The field releasing unit 216 is a processing unit that releases fields used by the storage devices 500 to 700 in accordance with a used-field release request from the file managing unit 214. The field releasing unit 216 uses the data stored in the file space 222 to acquire field management information. Then, the field releasing unit 216 renews the pool field 221 in a way that allows a reuse of the fields, which were released using the acquired management information, as available fields. Moreover, the field releasing unit 216 renews the file space 222 in accordance with the newly released fields.

The storage device interfacing unit 217 performs a writing of file data to the storage devices 500 to 700 and a reading of file data from the storage devices 500 to 700. The writing and the reading of data is performed in accordance with an address designated by the file managing unit 214.

The pool field 221 stores data for the management of available fields. The file space 222 stores data for the management of fields in the storage devices 500 to 700 that are occupied, that is, already full with data.

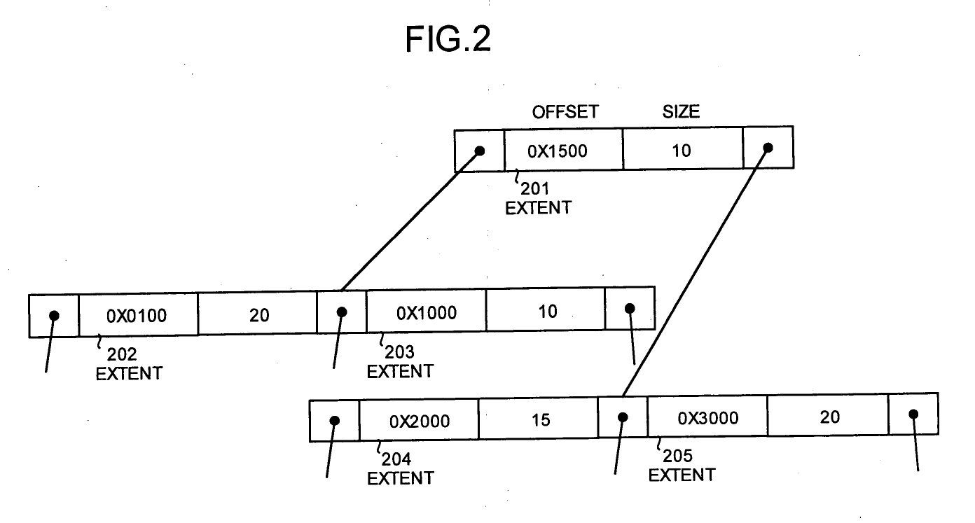

FIG. 2 is an exemplary diagram of a data structure of the pool field 221. The pool field 221 stores data that is used to manage available fields by the use of a B-Tree (Balanced multiway search Tree) that uses an extent as a node. Here, the extent is data that corresponds to an offset that shows a leading address and a size of the partial field of the storage devices 500 to 700. In other words, this network storage management apparatus 200 manages a plurality of variable-length fields of each storage device as an assemblage, and manages each variable-length field using the extents.

In FIG. 2, an extent 201 is the uppermost node of the B-Tree that manages the available fields of each storage device. The available field identified by this extent 201 has an offset of 0x1500 and a size of 10. Here, the 0x indicates an exponential in hexadecimal, with a unit size of 8 KB. In other words, a size of 10 means the size of the available field is 80 KB.

The extent 201 has child nodes, extents 202 and 203, which have left-side offset values that are smaller than those of the extent 201. The extent 201 also has other child nodes, extents 204 and 205, which have left-side offset values that are larger than those of the extent 201. In other words, the offsets of the extents 202 and 203 are 0x0100 and 0x1000, respectively; which are smaller than the offset 0x1500 of the extent 201. Moreover, the offsets of the extents 204 and 205 are 2x2000 and 0x3000, respectively; which are larger than the offset 0x1500 of the extent 201.

In this manner, the available fields of each storage device are, by means of the management by the B-Tree of which the offset is the key, able to flexibly manage each storage device. Moreover, the entirety of each storage device is managed as one available field. For example, the offset of a 10 GB hard disk is 0x0, so the size is 10 GB/8 KB=1280 which is managed by one extent. Then, the field allocating unit 215 allocates the required size of available field from the leading address of each storage device. In the midst of this allocation, if a non-serial available field is generated by the release performed by the field releasing unit 216, the field allocating unit 215 creates an extent that corresponds to the partially available field, and forms a B-Tree as a key for the offset of each partially available field.

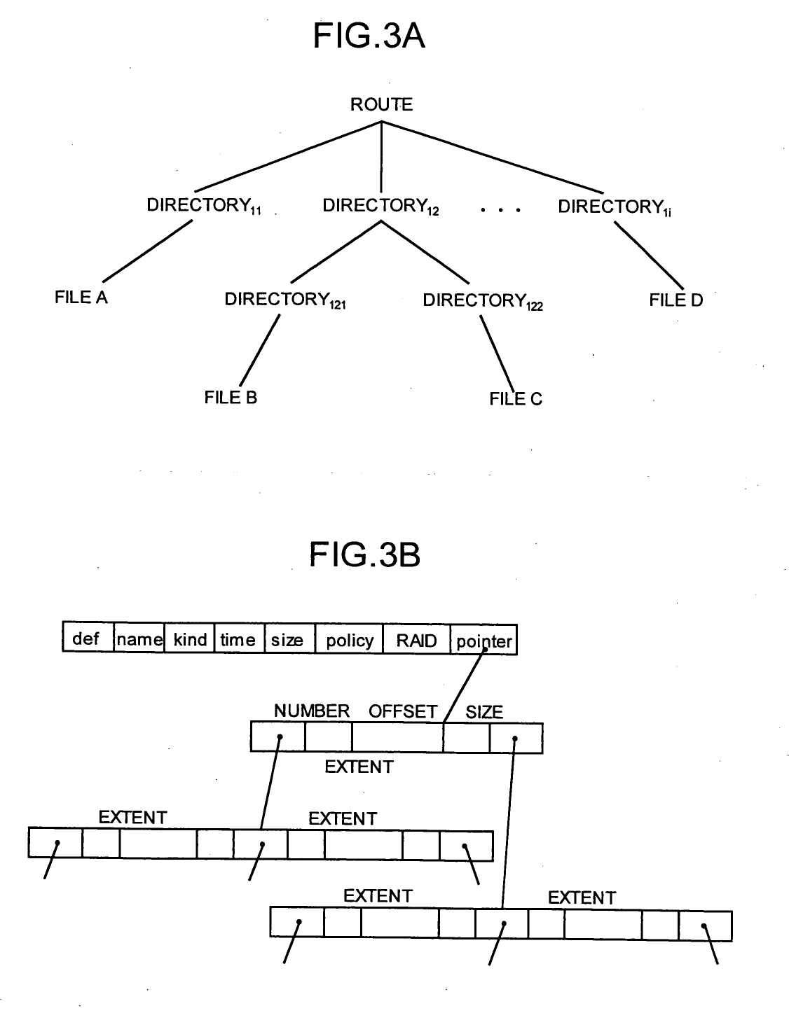

FIG. 3A is an exemplary diagram of data structure of the entire file space 222 and FIG. 3B is an exemplary diagram of data structure of the file space 222 of a single node. As shown in FIG. 3A, the file space 222 stores data that manages the files which uses the B-Tree as a directory and a node.

As shown in FIG. 3B, each node includes “def” that distinguishes whether the node is a directory or a file; “name”; “kind”; “time” that indicates the time of renewal; “size”; “policy” that indicates a policy attribute; “RAID” that indicates a RAID attribute; and “pointer” that indicates a storage location of the data when the node is a file.

Here, the policy attribute is the data used for policy control for storage of the directory or the file in a specific storage device. When the policy attribute is defined in the directory, that policy attribute continues in the subordinate directories and files. The RAID attribute is the data used to improve reliability of the file system. In concrete terms, when the RAID attribute is RAID0, data is divided and stored in a plurality of storage devices; when the RAID attribute is RAID1, copies of the data are created and stored in a separate storage device; and when the RAID attribute is RAID5, the data is divided and stored in a plurality of storage devices and, moreover, an exclusive logical sum is taken among the divided data and this resulting sum is stored in a separate storage device.

It is possible to easily actualize data backup functions by means of a combination of the policy attribute and the RAID attribute. In other words, when the policy attribute is RAID1, one among two storage devices is always the designated storage device that is used for backup purposes. If the available fields in the backup storage device are used up, it is possible, by an addition of new storage devices, to easily secure new available fields without affecting the existing data storage sections. “Pointer” indicates the location of a storage device that stores data when the node is a file. The data field of the file is, similar to an available field, configured from a plurality of partial fields that store data. The data field of the file is managed by the B-Tree that is a node that has an extent which distinguishes each partial field. The “pointer” designates the leading extent of this B-Tree.

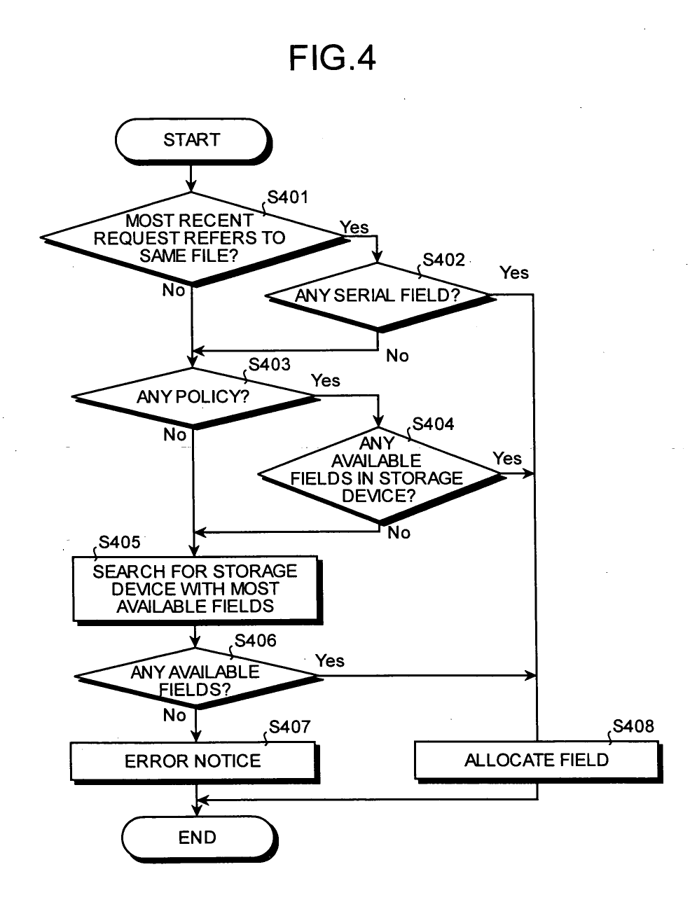

The following is an explanation of a process procedure performed by the field allocating unit 215 shown in FIG. 1. FIG. 4 is a flowchart of a process procedure performed by the field allocating unit 215. This field allocating unit 215 first checks whether the most recent field allocation request is a request that refers to the same file (step S401). If the request refers to the same file, the field allocating unit 215 uses an extent to check (step S402) whether a field which is consecutive to the most recently allocated field exists so as to allocate serial fields as much as possible. If a serial field exists, that field is allocated (step 408).

In contrast, if a serial field does not exist, or if the request does not refer to the same file, the field allocating unit 215 checks whether a policy exists (step S403). If a policy exists, the storage device designated by that policy is checked to find any available fields (step S404). If the storage device has sufficient available field, that available field is allocated (step S408). On the other hand, if the storage device designated by that policy does not have an available field, or if a policy does not exist, the field allocating unit 215 checks the storage device that has the most available fields (step S405). If there is an available field, that available field is allocated (step S408). If none of the storage devices have available fields, the field allocating unit 215 sends an error notice to the originator of the field allocation request (that is, one of the clients 10 to 30) (step S407).

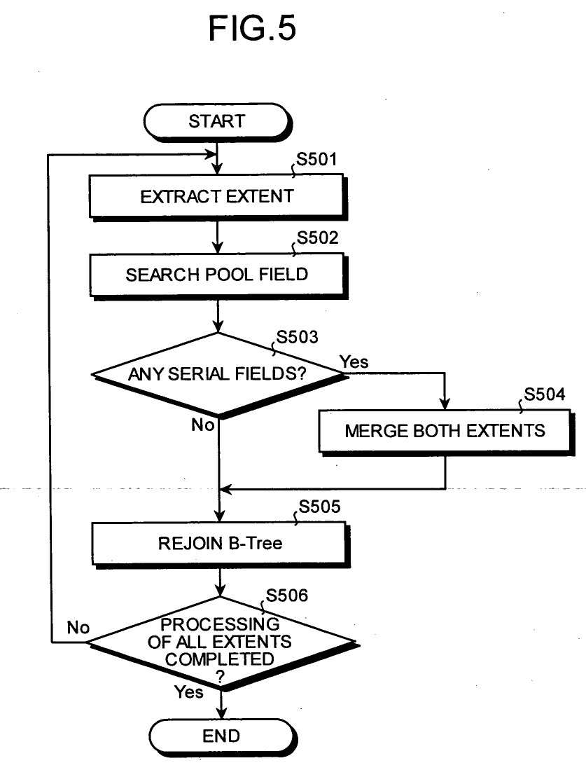

The following is an explanation of a process procedure performed by the field releasing unit 216 shown in FIG. 1. FIG. 5 is a flowchart of a process procedure performed by the field releasing unit shown in FIG. 1. The field releasing unit 216 extracts extents in consecutive order from the B-Tree which manages released fields (step S501). Then, the field releasing unit 216 searches the pool field 221 (step S502); and, using the offset and length of the extents of the pool field and the released extents, checks whether there are released fields and serial fields available (step S503). If a serial field is available, the two serial extents are merged to form one extent (step S504).

Then, the merged extent is rejoined to the B-Tree (step S505), and there is a check of whether processing of the extents of all the released fields has been completed (step S506). If processing has not been completed, the field releasing unit 216 returns to step S501 and processes the next extent. If processing of all the extents has been completed, field release processing ends.

As described above, in the present embodiment the data for managing the available fields of the storage devices 500 to 700 is stored in the pool field 221 in the form of a B-Tree. The data for managing fields used in the storage devices 500 to 700 is stored in the file space 222 also in the form of a B-Tree. The field allocating unit 215 uses the pool field 221 to allocate available fields. The field releasing unit 216 makes released fields into available fields by means of the file space 222. These operations allow an integrated management of NAS and SAN data, as well as the construction of a storage system that has easy expandability and a small operational load.

Moreover, the network driver 211 communicates with the clients 10 and 30 by means of NAS communication protocol; the storage network driver 212 communicates with the client 20 by means of SAN communication protocol; the protocol converting unit 213 converts the NAS, SAN, and internal protocols into each other; and the file managing unit 214 manages files in accordance with the commands, from the clients 10 to 30, that have been converted into internal protocol by the file managing unit 214. The result is that it is possible to construct a storage system in which NAS and SAN apparatuses can co-exist.

Furthermore, the policy attribute and RAID attribute of the files are stored in the file space 222, so it becomes possible to construct a storage system that has easy data backup and high reliability.

In addition, although the network storage management apparatus of the present embodiment is explained, it is possible to derive a computer program that actuates the configuration of the network storage management apparatus on a computer by means of software.

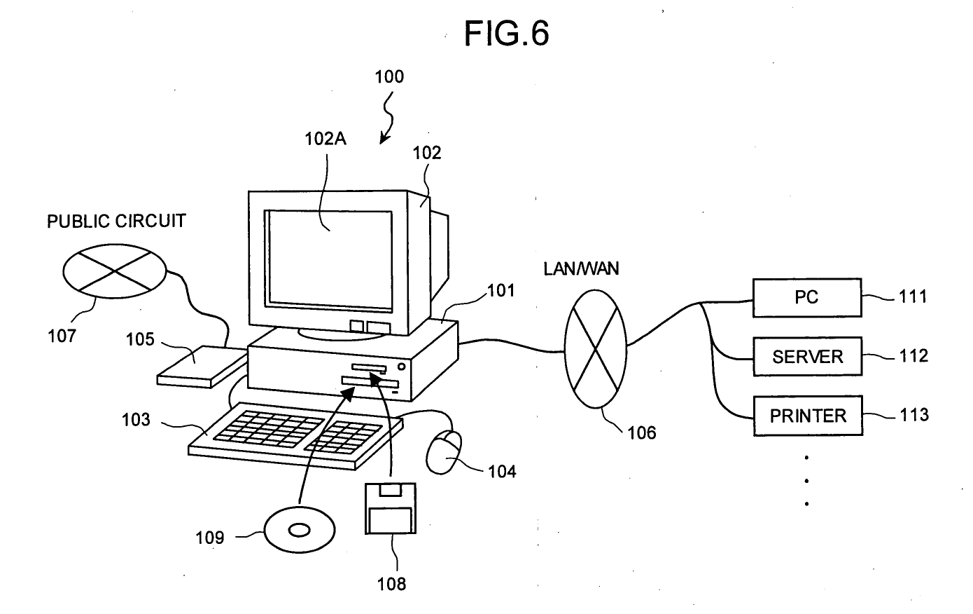

A computer system 100 shown in FIG. 6 is an example of the computer on which the computer program can be executed. The computer system 100 includes a main unit 101; a display 102 that displays information of images and the like on a display screen 102A in accordance with instructions from the main unit 101; a keyboard 103 for the input of various information to this computer system 100; a mouse 104 that specifies a position, chosen by the user, on the display screen 102A of the display 102; a LAN interface (not shown) that connects the computer system 100 to a local area network (LAN) or a wide area network (WAN) 106; and a modem 105 that connects the computer system 100 to a public circuit 107 of the Internet and the like. Here, the LAN/WAN 106 connects the computer system 100 to a personal computer (PC) 111 a server 112, a printer 113 and the like.

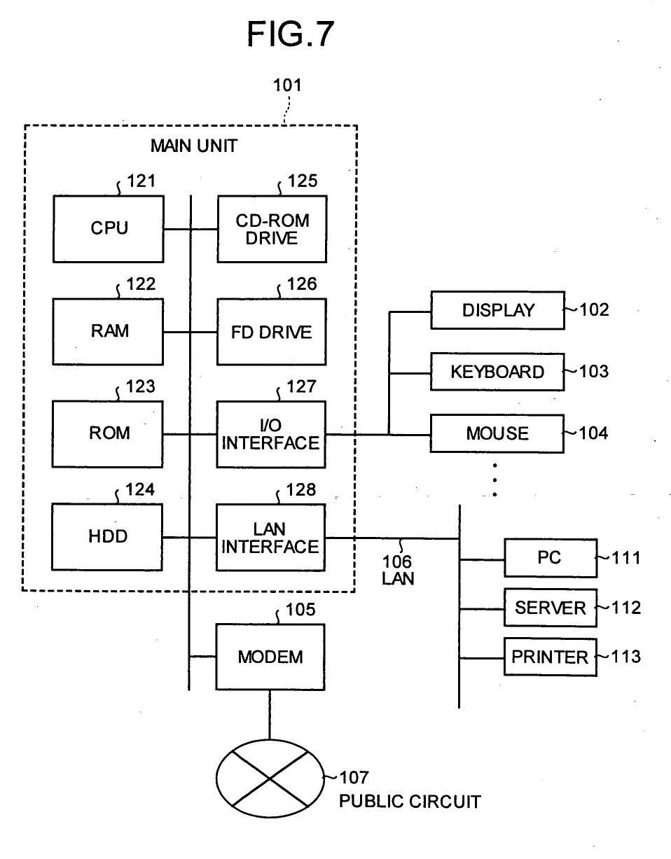

The internal components of the main unit 101 are shown in FIG. 7. The main unit 101 includes a central processing unit (CPU) 121, a random access memory (RAM) 122, a read-only-memory (ROM) 123, a hard disk drive (HDD) 124, a CD-ROM drive 125, a floppy disk (FD) drive 126, an input/output (I/O) interface 127, and a LAN interface 128.

The computer program that actuates the configuration of the network storage management apparatus is stored beforehand in a recordable medium and installed in the computer system 100. The recordable medium is a portable storage medium such as an FD 108, a CD-ROM 109, a DVD drive (not shown), a magneto-optical disk (not shown), an IC card (not shown), and the like; or a fixed recordable medium such as the HDD 124 of the computer system 100; or a database of the server 112; or an HDD or a database of the PC 111; or even a recordable medium accessible via the public circuit 107. When installed, the computer program is stored in the HDD 124. The CPU 121 executes the computer program by using the RAM 122 and the ROM 123.

According to the present invention allows construction of a storage system that permits the co-existence of differing architectures.

Although the invention has been described with respect to a specific embodiment for a complete and clear disclosure, the appended claims are not to be thus limited but are to be construed as embodying all modifications and alternative constructions that may occur to one skilled in the art which fairly fall within the basic teaching herein set forth.

1. A network storage management apparatus that connects a client and a storage device via a network, comprising:
an available-field-information storing unit that manages the storage device as a collection of partial fields, wherein an identifier is allocated to each partial field, collects identifiers of available partial fields, and stores the identifiers collected as information relating to an available field;
a field allocating unit that secures an available field based on the information relating to the available field, and from the information relating to the available field deletes the identifiers of the partial fields corresponding to the available field so as to convert the available field into an occupied field; and
a field releasing unit that releases the occupied field that has become unnecessary so as to convert the occupied field into an available field by adding identifiers in the information relating to the available field corresponding to the partial fields of the occupied field.

2. The network storage management apparatus according to claim 1, further comprising:
an occupied-partial-field-information storing unit that makes each of the storage device a memory field for a file, collects identifiers of partial fields that configures a data storage field of the file, and stores the identifiers collected as information relating to the occupied field along with information relating to the file, wherein
the field allocating unit secures the data storage field of the file, and
the field releasing unit releases the data storage field of a file that has become unnecessary as an available field.

3. The network storage management apparatus according to claim 2, further comprising a protocol converting unit that converts a plurality of types of protocols for network storage use to an internal protocol, wherein
the field allocating unit secures the available field in accordance with an available-field-securing-request of which a protocol is converted by the protocol converting unit, and
the field releasing unit releases the data storage field as the available field in accordance with an unnecessary-field-release-request of which a protocol is converted by the protocol converting unit.

4. The network storage management apparatus according to claim 1, wherein the identifier includes a leading address of a corresponding partial field and information relating to size of the corresponding partial field, and
the field allocating unit uses the information relating to the size of the partial field to secure the data storage field of appropriate size.

5. The network storage management apparatus according to claim 2, wherein the identifier includes identifying data for identifying the storage device, and
the information relating to the occupied field includes identifiers of the partial fields that are distributed in a plurality of the storage devices.

6. The network storage management apparatus according to claim 2, wherein the information relating to the available field and the information relating to the occupied field are stored by use of a B-Tree that makes the leading address a key.

7. The network storage management apparatus according to claim 2, wherein the information relating to the file includes information relating to controlling policy of each file and information relating to RAID, and the network storage management apparatus further comprising:
a backup creating unit that creates a backup of the files in the storage device in accordance with the information relating to controlling policy and the information relating to RAID.

8. A computer-readable recording medium that stores a computer program which when executed on a computer realizes a method of managing of storage devices, which is executed in a storage management apparatus that connects a client and a storage device via a network, comprising:
managing the storage device as a collection of partial fields, wherein an identifier is allocated to each partial field, collects identifiers of available partial fields, and stores the identifiers collected as information relating to an available field;
securing an available field based on the information relating to the available field, and from the information relating to the available field deleting the identifiers of the available partial fields corresponding to the available field so as to convert the available field into an occupied field; and
releasing the occupied field that has become unnecessary so as to convert the occupied field into an available field by adding identifiers in the information relating to the available field corresponding to the partial fields of the occupied field.

9. The computer-readable recording medium according to claim 8, wherein the computer program further makes the computer execute:
making each of the storage device a memory field for a file, collecting identifiers of partial fields that configures a data storage field of the file, and storing the identifiers collected as information relating to the occupied field along with information relating to the file, wherein
the securing includes securing the data storage field of the file, and
the releasing includes releasing the data storage field of a file that has become unnecessary as an available field.

10. The computer-readable recording medium according to claim 8, wherein the computer program further makes the computer execute converting a plurality of types of protocols for network storage use to an internal protocol, wherein
the securing includes securing the available field in accordance with an available-field-securing-request of which a protocol is converted at the converting, and
the releasing includes releasing the data storage field as the available field in accordance with an unnecessary-field-release-request of which a protocol is converted at the converting.

11. The computer-readable recording medium according to claim 8, wherein the identifier includes a leading address of a corresponding partial field and information relating to size of the corresponding partial field, and
the securing includes using the information relating to the size of the partial field to secure the data storage field of appropriate size.

12. The computer-readable recording medium according to claim 9, wherein the identifier includes identifying data for identifying the storage device, and
the information relating to the occupied field includes identifiers of the partial fields that are distributed in a plurality of the storage devices.

13. The computer-readable recording medium according to claim 9, wherein the information relating to the available field and the information relating to the occupied field are both stored by use of a B-Tree that makes the leading address a key.

14. The computer-readable recording medium according to claim 9, wherein the information relating to the file includes information relating to controlling policy of each file and information relating to RAID, wherein the computer program further makes the computer execute:
creating a backup of the files in the storage device in accordance with the information relating to controlling policy and the information relating to RAID.

15. A method of managing storage devices, which is executed in a storage management apparatus that connects a client and a storage device via a network, comprising:
managing the storage device as a collection of partial fields, wherein an identifier is allocated to each partial field, collects identifiers of available partial fields, and stores the identifiers collected as information relating to the available field;
securing an available field based on the information relating to the available field, and from the information relating to the available field deleting the identifiers of the available partial fields corresponding to the available fields so as to convert the available field into an occupied field; and
releasing the occupied field that has become unnecessary so as to convert the occupied field into an available field by adding identifiers in the information relating to the available field corresponding to the partial fields of the occupied field.

16. The method according to claim 15, further comprising:
making each of the storage device a memory field for a file, collecting identifiers of partial fields that configures a data storage field of the file, and storing the identifiers collected as information relating to the occupied field along with information relating to the file, wherein
the securing includes securing the data storage field of the file, and
the releasing includes releasing the data storage field of a file that has become unnecessary as an available field.

17. The method according to claim 16, further comprising converting a plurality of types of protocols for network storage use to an internal protocol, wherein
the securing includes securing the available field in accordance with an available-field-securing-request of which a protocol is converted at the converting, and
the releasing includes releasing the data storage field as the available field in accordance with an unnecessary-field-release-request of which a protocol is converted at the converting.

18. The method according to claim 15, wherein the identifier includes a leading address of a corresponding partial field and information relating to size of the corresponding partial field, and
the securing includes using the information relating to the size of the partial field to secure the data storage field of appropriate size.

19. The method according to claim 16, wherein the identifier includes identifying data for identifying the storage device, and
the information relating to the occupied field includes identifiers of the partial fields that are distributed in a plurality of the storage devices.

20. The method according to claim 16, wherein the information relating to the available field that is stored by the available-partial-field-information storing unit and the information relating to the occupied field that is stored by the occupied-partial-field-information storing unit are stored by use of a B-Tree that makes the leading address a key.

21. The method according to claim 16, wherein the information relating to the file includes information relating to controlling policy of each file and information relating to RAID, and the method further comprising:
creating a backup of the files in the storage device in accordance with the information relating to controlling policy and the information relating to RAID.
